(19) United States
(12) Patent Application Publication
(10) Pub. No.: US 2026/0128470 A1
(43) Pub. Date: May 7, 2026

(54) COMPOSITE SEPARATOR AND ELECTROCHEMICAL DEVICE COMPRISING THE SAME

(71) Applicant: SK IE TECHNOLOGY CO., LTD., Seoul (KR)

(72) Inventors: Cheol Min YUN, Daejeon (KR); Dong Jae KIM, Daejeon (KR); Eun Ji OH, Daejeon (KR); Hee Joon JUNG, Daejeon (KR)

(21) Appl. No.: 19/368,903

(22) Filed: Oct. 24, 2025

(30) Foreign Application Priority Data
Nov. 7, 2024 (KR) 10-2024-0156782

(51) Int. Cl. H01M 50/451; H01M 10/052; H01M 50/42; H01M 50/423; H01M 50/429; H01M 50/434; H01M 50/491

(52) U.S. Cl. CPC H01M 50/451; H01M 10/052; H01M 50/42; H01M 50/423; H01M 50/4295; H01M 50/434; H01M 50/491

(57) ABSTRACT

Composite separators, methods for manufacturing the composite separators, and electrochemical devices including the composite separators are disclosed. In an embodiment, a composite separator includes a porous substrate, and a ceramic layer formed on at least one surface of the substrate. The ceramic layer includes inorganic particles, a binder that includes carboxymethyl cellulose and polyacrylamide, and a particulate fusing agent. The ceramic layer satisfies the following Equation 1.

$$0.9 < \frac{T \times ( W 1 + W 2 )}{W 2 \times D} < 2.4 \qquad [ Equation 1 ]$$

wherein T, W1, W2, and D are as defined in the specification.

The composite separator may secure excellent heat resistance, adhesive strength, and fusion strength with an electrode.

This patent document claims the priority and benefits of Korean Patent Application No. 10-2024-0156782, filed on Nov. 7, 2024, the disclosure of which is incorporated herein by reference in its entirety.

### TECHNICAL FIELD

The disclosed technology relates to a composite separator and an electrochemical device including the same.

### BACKGROUND

In recent years, as electrochemical devices have gained greater capacity and output, there has been a growing demand for improved heat resistance and safety. In particular, the performance requirements for separators, which play an important role in ensuring the heat resistance and safety of the electrochemical devices, have become more advanced. For example, composite separators comprising an inorganic coating layer that includes inorganic particles such as alumina (Al₂O₃), silica (SiO₂), and zirconia (ZrO₂), along with a binder applied to a porous substrate, have emerged as an important technology.

### SUMMARY

An embodiment of the disclosed technology provides a composite separator that includes a ceramic layer along with a particulate fusing agent applied to the ceramic layer, thereby exhibiting excellent heat resistance, adhesive strength, and fusion strength with an electrode.

Another embodiment of the disclosed technology provides an electrochemical device that includes the composite separator.

In one general aspect, a composite separator includes: a porous substrate; and a ceramic layer disposed on at least one surface of the substrate, wherein the ceramic layer includes: inorganic particles; a binder including carboxymethyl cellulose and polyacrylamide; and a particulate fusing agent, wherein the ceramic layer satisfies the following Equation 1:

$$0.9 < \frac{T \times ( W 1 + W 2 )}{W 2 \times D} < 2.4 \qquad [ Equation 1 ]$$

Wherein:
T is a thickness in microns (μm) of the ceramic layer;
W1 is a content weight percentage (wt %) of the binder relative to the total weight of the ceramic layer;
W2 is a content weight percentage (wt %) of the particulate fusing agent relative to the total weight of the ceramic layer; and
D is an average particle diameter in microns (μm) of the particulate fusing agent.

The average particle diameter (D50) of the particulate fusing agent may be in a range of 1 μm to 10 μm.

The ceramic layer may have a total thickness in a range of 1 μm to 20 μm.

The binder may include the carboxymethyl cellulose and the polyacrylamide at a weight ratio in a range of 10 to 40:90 to 60.

The carboxymethyl cellulose may have a weight-average molecular weight of at least 180,000 g/mol and a degree of substitution in a range of 0.6 to 1.2.

The average particle diameter (D₅₀) of the inorganic particles may be in a range 0.01 μm to 1 μm.

The inorganic particles may include at least one of boehmite, BaSO₄, CeO₂, MgO, CaO, ZnO, Al₂O₃, TiO₂, BaTiO₃, HfO₂, SrTiO₃, SnO₂, NiO, ZrO₂, Y₂O₃, or SiC.

The inorganic particles may be included at 90 to 99 wt % with respect to the total weight of the ceramic layer.

The binder may be included at 0.1 wt % to 10 wt % with respect to the total weight of the ceramic layer.

The particulate fusing agent may be included at 0.1 wt % to 10 wt % with respect to the total weight of the ceramic layer.

The binder and the particulate fusing agent may be included at a weight ratio in a range of 5:5 to 8:2.

The particulate fusing agent may have a glass transition temperature (T_{g}) in a range of 40° C. to 80° C.

The porous substrate may be hydrophilically surface-treated.

The composite separator implemented based on an example embodiment may exhibit heat shrinkage rates in machine direction (MD) and transverse direction (TD) of 4% or less, wherein the heat shrinkage rates in MD and TD are measured after the composite separator is allowed to stand at 150° C. for 60 minutes.

The heat shrinkage rate of the composite separator was measured based on the ASTM D1204 standard, but the following method was used. Lattice points were marked at 2 cm intervals on a square with one side of 10 cm on the composite separator specimen, and one side of the square was the transverse direction (TD) and the other one was the machine direction (MD). The specimen was placed right in the center, 5 sheets of paper were placed on and under the specimen, respectively, the four sides of the paper were taped, and the taped specimen was allowed to stand in a hot air drying oven at 150° C. for 60 minutes. Thereafter, the specimen was taken out, and the separator was observed with a camera to calculate the shrinkage rate in the machine direction (MD) and the shrinkage rate in the transverse direction (MD) at an ambient temperature.

When the composite separator implemented based on an example embodiment is subjected to a cardboard test, a ratio of an area occupied by foreign matter smeared on a surface of a cardboard to a total area of the cardboard may be 5% or less,

Here, the cardboard test may comprise:
placing a black cardboard and a rubber pad having a size of 2 cm×10 cm sequentially on a ceramic layer of a composite separator specimen having a size of 5 cm×10 cm; pulling the cardboard horizontally at a speed of 0.1 m/s for a distance of 60 mm while applying a force of 10 N is applied to the rubber pad using a pressing device; and evaluating a degree of foreign matter smeared on the surface of the cardboard.

In another general aspect, an electrochemical device includes: a positive electrode, a negative electrode, and a composite separator, wherein the composite separator includes: a porous substrate; and a ceramic layer disposed on at least one surface of the substrate, wherein the ceramic layer includes: inorganic particles; a binder including carboxymethyl cellulose and polyacrylamide; and a particulate fusing agent, wherein the ceramic layer satisfies the following Equation 1:

$$0.9 < \frac{T \times ( W 1 + W 2 )}{W 2 \times D} < 2.4 \qquad [ Equation 1 ]$$

wherein
T is a thickness in microns (μm) of the ceramic layer;
W1 is a content weight percentage (wt %) of the binder relative to the total weight of the ceramic layer;
W2 is a content weight percentage (wt %) of the particulate fusing agent relative to the total weight of the ceramic layer; and
D is an average particle diameter in microns (μm) of the particulate fusing agent.

Other features and aspects will be apparent from the following detailed description, the drawings, and the claims.

### BRIEF DESCRIPTION OF THE DRAWINGS

FIG. 1 shows a cross section of a composite separator according to an example embodiment.

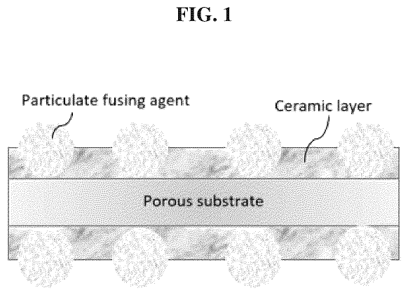

### DETAILED DESCRIPTION

The numerical range used in some embodiments includes all values within the range including the lower limit and the upper limit, increments logically derived from the form and spanning of a defined range, all double limited values, and all possible combinations of the upper limit and the lower limit in the numerical range defined in different forms. Unless otherwise defined in this patent document, values which may be outside a numerical range due to experimental error or rounding off of a value are also included in the defined numerical range.

Unless otherwise particularly defined in embodiments, “about” may be considered as a value within 30%, 25%, 20%, 15%, 10%, or 5% of a stated value.

In some embodiments, an “average particle diameter” refers to “D50”, and “D50” refers to a particle diameter of a sample particle to be measured which corresponds to 50% in terms of a volume-based accumulated fraction, i.e., 50% of the particles in the material with diameters less than the diameter D50. The average particle diameter may be derived from particle size distribution results obtained by collecting a sample of particles to be measured in accordance with the standard of ISO 13320-1 and performing analysis using analytical instruments for particle size and shape (e.g., S3500 available from MICROTRAC), in which the sample to be measured refers to inorganic particles and a particulate fusing agent.

In some embodiments, carboxymethyl cellulose (CMC) refers to a cellulose derivative that is etherified by substituting a hydroxyl group (—OH) of cellulose with —OCH₂COOH and/or —OCH₂COO⁻ M⁺ where M⁺ is an alkali metal cation selected from lithium (Li), sodium (Na), potassium (K), rubidium (Rb), cesium (Cs), francium (Fr), and others. In some embodiments, the term “degree of substitution (DS)” of carboxymethyl cellulose refers to the number of substituents present in one anhydrous glucose unit in a cellulose molecule. The DS value may be measured by a known or conventional method, for example, in accordance with ASTM D1439 or calculated by ¹H-NMR or ¹³C-NMR analysis.

The degree of substitution (DS) of carboxymethyl cellulose (CMC) was measured according to a titration method based on ASTM D1439. The experiment was carried out using a magnetic stirrer, aspirator, dry oven, 300 mL beaker, pipette, 250 mL Erlenmeyer flask, and Petri dish. The reagents used included 80% ethanol, 100% ethanol, 0.1 N sodium hydroxide (NaOH), phenolphthalein indicator, and 0.1 N sulfuric acid (H₂SO₄). Specifically, 150 mL of 80% ethanol was added to a 300 mL beaker, followed by 10 mL of 1 N nitric acid (HNO₃). Approximately 1-2 g of CMC sample was introduced into the beaker and stirred for 1 hour to convert the sodium salt form of CMC into the acid form (CMC-acid). After allowing the mixture to stand for about 10-20 minutes, the supernatant was decanted. Then, 150 mL of 80% ethanol was added again and stirred for 30-40 minutes, followed by decanting the supernatant once more. The precipitated CMC-acid was filtered using an aspirator and washed with 500 mL of 80% ethanol, followed by one or two washes with 100% ethanol. The central portion of the CMC-acid was collected in a clean weighing dish and dried in a dry oven for 20-30 minutes. After drying, approximately 0.2±0.05 g of the dried sample was weighed accurately, and 25 mL of 0.1 N NaOH solution was added. The sample solution was then transferred to a 250 mL Erlenmeyer flask containing 100 mL of distilled water and stirred for 40-60 minutes until completely dissolved. Two to three drops of phenolphthalein were added as an indicator, and the solution was titrated with 0.1 N H₂SO₄ while stirring until the color changed from red to colorless. The number of millimoles of CMC-acid per gram of dried sample (A) was determined according to the following equation:

$$A = \frac{( millimoles of CMC Acid )}{Sample dry weight ( g )}$$

The degree of substitution (DS) was then calculated from A using the following equation:

$$B ( D . S . value ) = \frac{162 \times A}{10 , 000 - 58 \times A} .$$

In many cases, composite separators exhibit insufficient adhesion to electrodes. As a result, the separator and electrode may separate during cell assembly, leading to distortion or deformation of the electrode assembly, and even short circuits between electrodes, resulting in safety issues. To address these issues, a method can be considered in which an adhesive layer capable of forming fusion strength with an electrode is applied over an inorganic coating layer. However, this approach may be difficult to commercialize due to addition process steps and increased manufacturing costs. Furthermore, the added adhesive layer may increase the internal resistance of a battery and potentially degrade its electrical performance.

Hereinafter, the disclosed technology will be described in detail. However, it is only illustrative, and the disclosed technology is not limited to the specific example embodiment illustratively described.

In some approaches, a separate adhesive layer is applied to an inorganic coating layer to improve fusion strength of a composite separator, which includes an inorganic coating layer on a porous substrate, with an electrode. However, such approaches may be difficult to commercialize due to additional process steps and increasing manufacturing costs. Furthermore, the added adhesive layer could increase internal resistance of a battery and degrade electrical performance. In addition, separators have recently become thinner to meet the requirements for high-capacity, high-output electrochemical devices. The disclosed technology can be implemented in some embodiments to provide a new separator that can simultaneously (i)secure sufficient fusion strength, (ii) maintain excellent adhesive strength between inorganic particles and between inorganic particles and a substrate in an inorganic coating layer even within a reduced thickness range, and (iii) prevent heat shrinkage at high temperatures.

An example embodiment of the disclosed technology provides a composite separator that may secure fusion strength with an electrode without the need for a separate adhesive layer, while simultaneously (i) exhibiting excellent adhesive strength between inorganic particles, (ii) exhibiting excellent adhesive strength between inorganic particles and a substrate, and (iii) providing excellent heat resistance.

Specifically, the composite separator based on an example embodiment includes: a porous substrate; and a ceramic layer disposed on at least one surface of the substrate, wherein the ceramic layer includes: inorganic particles; a binder including carboxymethyl cellulose and polyacrylamide; and a particulate fusing agent, wherein the ceramic layer satisfies the following Equation 1:

$$0.9 < \frac{T \times ( W 1 + W 2 )}{W 2 \times D} < 2.4 \qquad [ Equation 1 ]$$

Wherein:
T is a thickness in micrometers or microns (μm) of the ceramic layer;
W1 is a content weight percentage (wt %) of the binder relative to the total weight of the ceramic layer;
W2 is a content weight percentage (wt %) of the particulate fusing agent relative to the total weight of the ceramic layer; and
D is an average particle diameter in microns (μm) of the particulate fusing agent.

The composite separator implemented based on an example embodiment can achieve sufficient adhesion to the electrode by applying a specific combination of mixed binders as described above. In addition, it can satisfy the range defined by Equation 1 through a specific correlation among (i) the thickness of the ceramic layer, (ii) the content of the binder and the particulate fusing agent, and (iii) the average particle size of the particulate fusing agent. Compared to a separator having a ceramic layer of the same thickness, the composite separator can exhibit excellent heat resistance. Furthermore, the adhesion between the inorganic particles and between the inorganic particles and the substrate is improved, thereby effectively suppressing particle detachment and thermal shrinkage at high temperatures.

In an example embodiment, Equation 1 may be within a range of more than 0.9 and less than 2.4, for example, 0.91 to 2.3, 0.91 to 2.3, 0.91 to 2.2, or 0.92 to 2.2. The numerical range disclosed herein may include all possible combinations of the upper limits and the lower limits of the numerical ranges. Satisfying Equation 1 within the above range can simultaneously improve fusion strength and heat resistance, and can improve the stability and capacity of a battery.

Equation 1 is related to each ceramic layer, and when the composite separator implemented based on an example embodiment includes the ceramic layer formed on two opposite surfaces of the porous substrate, the thickness (T) of the ceramic layer in Equation 1 refers to the thickness of the ceramic layer formed on one surface.

In an example embodiment, the thickness (T) of the ceramic layer is not particularly limited as long as the range of Equation 1 is satisfied by the combination of the content (W1) of the binder, the content (W2) of the particulate fusing agent, and the average particle diameter (D) of the particulate fusing agent, but may be, for example, 0.1 μm to 10 μm, 0.5 μm to 10 μm, 0.5 μm to 8 μm, 0.5 μm to 5 μm, 1 μm to 5 μm, 1.2 μm to 5 μm, or 1.5 μm to 3 μm. The numerical range disclosed herein may include all possible combinations of the upper limits and the lower limits of the numerical ranges.

In an example embodiment, the total thickness of the ceramic layer may be 0.1 μm to 20.0 μm, 0.1 μm to 10.0 μm, 0.5 μm to 10.0 μm, 1 μm to 10 μm, 2 μm to 8 μm, 2 μm to 5 μm, or 3 μm to 5 μm. The numerical range disclosed herein may include all possible combinations of the upper limits and the lower limits of the numerical ranges. In some embodiments, the total thickness of the ceramic layer refers to the thickness of the ceramic layer formed on one surface of the porous substrate when the composite separator implemented based on an example embodiment includes the ceramic layer formed on one surface of the porous substrate. In some embodiments, the total thickness of the ceramic layer refers to the sum of the thicknesses of the ceramic layers formed on two opposite surfaces of the porous substrate when the composite separator implemented based on an example embodiment includes the ceramic layer formed on two opposite surfaces of the porous substrate, and the thicknesses of the ceramic layer formed on two opposite surfaces may be the same as or different from each other.

In an example embodiment, the binder may include the carboxymethyl cellulose and the polyacrylamide at a weight ratio of 10 to 50:90 to 50 or 10 to 40:90 to 60.

The binder may use the combination of carboxymethyl cellulose and polyacrylamide at 70 wt % or more, 80 wt % or more, 90 wt % or more, 95 wt % or more, or 100 wt %, with respect to the total weight of the binder. Preferably, the binder may be composed of the carboxymethyl cellulose and the polyacrylamide (100 wt %), which is more preferred.

In an example embodiment, the carboxymethyl cellulose may have a weight-average molecular weight of 180,000 g/mol or more, 190,000 g/mol or more, or 200,000 g/mol or more and 2,000,000 g/mol or less, 1,800,000 g/mol or less, 1,500,000 g/mol or less, 1,300,000 g/mol or less, or 1,000,000 g/mol or less, specifically 180,000 to 2,000,000 g/mol, 180,000 to 1,500,000 g/mol, 180,000 to 1,300,000 g/mol, or 200,000 to 1,000,000 g/mol. The numerical range disclosed herein may include all possible combinations of the upper limits and the lower limits of the numerical ranges. The weight-average molecular weight may refer to a weight-average molecular weight converted with a molecular weight calibration curve using a polysaccharide standard sample measured by a gel permeation chromatography (GPC) method. The GPC method may be carried out at an ambient temperature, and the sample is prepared by dissolving CMC at a concentration of approximately 0.1% w/v in a standard reference solvent. The prepared solution is then injected into the GPC instrument for analysis.

In addition, the carboxymethyl cellulose may have the degree of substitution of 0.6 or more, 0.7 or more, 0.8 or more, 0.9 or more, 1.5 or less, 1.2 or less, 1.1 or less, or 1.0 or less, specifically, 0.6 to 1.5, 0.6 to 1.2, 0.6 to 1.1, 0.7 to 1.1, 0.7 to 1.0, or 0.8 to 1.0. The numerical range disclosed herein may include all possible combinations of the upper limits and the lower limits of the numerical ranges.

By using carboxymethyl cellulose that satisfies the combination of the weight-average molecular weight and the degree of substitution range, the effect of simultaneously improving heat resistance and adhesive strength may be further enhanced. For example, the use of such carboxymethyl cellulose can provide excellent applicability when applying a coating slurry to the surface of the porous substrate during formation of the ceramic layer. In addition, excellent heat resistance can be maintained even when the ceramic layer of the composite separator has a small thickness, and the adhesive strength between the inorganic particles or between the ceramic layer and the porous substrate can be improved.

In an example embodiment, the polyacrylamide (PAAm) may be a homopolymer including 100 mol % of an acrylamide polymerization unit. When the polyacrylamide is a copolymer that further includes a polymerization unit derived from monomers other than acrylamide, such as a copolymerization unit selected from a vinylalcohol unit, an acrylonitrile unit, an acrylic acid unit, and others, a side reaction with a positive electrode, a negative electrode, an electrolytic solution may occur, degrading battery performance. Therefore, some embodiments use a polyacrylamide homopolymer. However, a content of the copolymerization unit that does not cause unacceptable performance degradation may be allowable. For example, the copolymerization unit content may be limited to 5 mol % or less, 3 mol % or less, 1 mol % or less, 0.5 mol % or less, or 0.1 mol % or less.

The polyacrylamide may have a weight-average molecular weight of 100,000 g/mol or more, 150,000 g/mol or more, 180,000 g/mol or more and 500,000 g/mol or less, 400,000 g/mol or less, 300,000 g/mol or less, or 250,000 g/mol or less, and specifically, 100,000 g/mol to 300,000 g/mol, 150,000 to 250,000 g/mol. The numerical range disclosed herein may include all possible combinations of the upper limits and the lower limits of the numerical ranges, but the disclosed technology is not limited thereto. The weight-average molecular weight may refer to a weight-average molecular weight converted with a molecular weight calibration curve using a polystyrene standard sample measured by a GPC method.

In an example embodiment, the particulate fusing agent may have an average particle size of 1 μm or more, 1.5 μm or more, 2.0 μm or more, 2.5 μm or more and 10 μm or less, 8 μm or less, 6 μm or less, or 5 μm or less, or 1 μm to 10 μm, 1 μm to 8 μm, 1 μm to 6 μm, or 2 μm to 6 μm. The numerical range disclosed herein may include all possible combinations of the upper limits and the lower limits of the numerical ranges, and make fusion strength with an electrode better.

In an example embodiment, the particulate fusing agent may have a glass transition temperature (T_{g}) of 40° C. or higher, 45° C. or higher, 50° C. or higher and 100° C. or lower, 90° C. or lower, or 80° C. or lower, or 40° C. to 100° C., 40° C. to 90° C., or 40° C. to 80° C. The numerical range disclosed herein may include all possible combinations of the upper limits and the lower limits of the numerical ranges. When the range is satisfied, fusion strength between the composite separator and the electrode may be enhanced, and the battery can exhibit improved battery performance after battery assembly. In some embodiments, the glass transition temperature may be in a range from 40° C. to 70° C. Within this range, the fusing agent may not flow in a drying step of the composite separator, is not deformed in a coating step and during a shipping process, and minimizes changes in the air permeability of the substrate even after fusing, thereby maintaining excellent performance.

The particulate fusing agent is not particularly limited as long as it can provide fusion strength with an electrode, but may, for example, be an acryl-based polymer, a urethane-based polymer, or a copolymer including them.

The acryl-based polymer may be a homopolymer including an alkyl (meth)acrylate-based monomer polymerization unit or a copolymer including the alkyl (meth)acrylate-based monomer polymerization unit. The copolymer including the alkyl (meth)acrylate-based monomer polymerization unit may be a copolymer including an alkyl (meth)acrylate-based monomer polymerization unit; and one or more polymerization units selected from a styrene-based monomer polymerization unit, a butadiene-based monomer polymerization unit, and a vinyl-based monomer polymerization unit.

The alkyl (meth)acrylate-based monomer may be a C1-C10 alkyl (meth)acrylate-based monomer, C1-C6 alkyl (meth)acrylate-based monomer, or C1-C4 alkyl (meth)acrylate-based monomer, and specifically, one or more selected from methyl (meth)acrylate, ethyl (meth)acrylate, and n-butyl (meth)acrylate.

A non-limiting example of the particulate fusing agent may be polyurethane beads, polyurethane acryl beads, epoxy-acryl beads, polystyrene-polybutyl methacrylate-polymethyl methacrylate (PS-PBMA-PMMA), polybutyl methacrylate-polymethyl methacrylate (PBMA-PMMA) polystyrene-polydimethylsiloxane-polybutyl methacrylate (PS-PDMS-PBMA), polystyrene-polydimethylsiloxane-polymethyl methacrylate (PS-PDMS-PMMA), or polydimethylsiloxane-polymethyl methacrylate (PDMS-PMMA), but the disclosed technology is not limited thereto.

In some embodiments, the particulate fusing agent may be manufactured by a known manufacturing method, such as emulsion polymerization or suspension polymerization, and thus, detailed description thereof will be omitted.

In an example embodiment, the type of inorganic particles is not limited. As a non-limiting example, may be one or more selected from metal oxides, metal hydroxide, metal carbides, metal nitrides, and metal carbonitrides, such as boehmite, BaSO₄, CeO₂, MgO, CaO, ZnO, Al₂O₃, TiO₂, BaTiO₃, HfO₂, SrTiO₃, SnO₂, NiO, ZrO₂, Y₂O₃, and SiC.

In an example embodiment, the inorganic particles may have an average particle diameter (D50) of, for example, 0.01 μm or more, 0.02 μm or more, 0.05 μm or more, 0.1 μm pm or more and 0.01 μm to 10 μm, 0.02 μm to 5.0 μm, 0.1 μm to 3.0 μm, 0.1 μm to 2.0 μm, 0.1 μm to 1.0 μm, or 0.1 μm to 0.5 μm. The numerical range disclosed herein may include all possible combinations of the upper limits and the lower limits of the numerical ranges, but the disclosed technology is not limited thereto.

In an example embodiment, the ceramic layer may include the inorganic particles at 90 to 99.9 wt %, 92 to 99.5 wt %, 92 to 99 wt %, 90 to 99 wt %, 95 to 99 wt %, or 95 to 98 wt %, with respect to the total weight of the ceramic layer.

In an example embodiment, the content (W1) of the binder may be 0.01 wt % or more, 0.1 wt % or more, 0.5 wt % or more, 1 wt % or more, 1.5 wt % or more, 2 wt % or more, 10 wt % or less, 8 wt % or less, or 5 wt % or less, or 0.01 wt % to 10 wt %, 0.1 wt % to 10 wt %, 0.5 wt % to 5 wt %, or 1 to 5 wt %, with respect to the total weight of the ceramic layer. The numerical range disclosed herein may include all possible combinations of the upper limits and the lower limits of the numerical ranges.

In an example embodiment, the content (W2) of the particulate fusing agent may be 0.1 wt % or more, 0.5 wt % or more, 1.0 wt % or more, more than 1.0 wt %, 1.1 wt % or more, or 1.2 wt % or more and, 10 wt % or less, 5 wt % or less, 4 wt % or less, 3 wt % or less, 2 wt % or less, or less than 2 wt %, specifically 0.5 wt % to 5 wt %, 1 wt % to 5 wt %, 1 wt % to 3 wt %, 1 wt % to 2 wt %, or more than 1 wt % and less than 2 wt %, with respect to the total weight of the ceramic layer. The numerical range disclosed herein may include all possible combinations of the upper limits and the lower limits of the numerical ranges.

In an example embodiment, the ceramic layer may include the binder at 10 parts by weight or less, 8 parts by weight or less, 5 parts by weight or less, 3 parts by weight or less, 2 parts by weight or less, or 1 part by weight or less and 0.01 parts by weight or more, 0.1 parts by weight or more, 0.5 parts by weight or more, 1 part by weight or more, 2 parts by weight or more, specifically 0.1 to 5 parts by weight, 1 to 5 parts by weight, or 1 to 3 parts by weight, with respect to 100 parts by weight of the inorganic particles, or at a content between the numerical ranges.

In an example embodiment, the binder and the particulate fusing agent may be included at a weight ratio of 5:5 to 9:1, 5:5 to 8:2, or 5:5 to 7:3.

In an example embodiment, heat shrinkage rates in MD and TD directions of the composite separator, measured after the separator is allowed to stand at 150° C. for 60 minutes, may each be 5% or less, specifically 3% or less, 2.5% or less, 2.0% or less, 1.5% or less, 1.0% or less, or 0.5% or less.

In addition, in an example embodiment, when a degree of foreign matter smeared on the surface of a cardboard is evaluated after a cardboard test of the composite separator, a ratio of an area occupied by the smeared foreign matter to an area of the cardboard may be 5% or less, specifically less than 5%, less than 4%, less than 3%, less than 2%, or less than 1.5%.

The cardboard test method involves placing a black cardboard and a rubber pad having a size of 2 cm×10 cm sequentially on an upper surface of a ceramic layer of a composite separator specimen having a size of 5 cm×10 cm, and pulling out the cardboard horizontally at a speed of 0.1 m/s for a distance of 60 mm in a state of applying a force of 10 N to the rubber pad using a pressing device to evaluate an area as a degree of foreign matter smeared on the surface of the cardboard, in which the foreign matter may be the constituent components of the ceramic layer, for example, the inorganic particles, the binder, or a combination thereof.

When the adhesive strength is evaluated using the cardboard test method as described above, measurement may be performed considering adhesive strength between the inorganic particles in the ceramic layer as well as adhesive strength between interfaces of the substrate and the ceramic layer, and from the results of the adhesive strength test, a heat shrinkage degree may be predicted more accurately as compared with a conventional peel test. That is, when a ratio of an area occupied by the smeared foreign matter calculated by the cardboard test is less than 5%, less than 4%, less than 3%, less than 2%, or less than 1.5%, it means that adhesive strengths between the inorganic particles and between the inorganic particles and the substrate are all excellent, and the heat shrinkage phenomenon may be effectively suppressed.

As an example, a method such as a peeling test commonly used for evaluating adhesive strength of an inorganic particle coating layer in a composite separator can be used to evaluate adhesive strength between interfaces of the substrate and the inorganic particle coating layer. However, it may be difficult to evaluate the adhesive strength between the inorganic particles, or the evaluated value may not accurately reflect the heat shrinkage characteristics of the separator.

In an example embodiment, the porous substrate is not limited as long as it is commonly used in the art, and for example, may be a woven fabric, a non-woven fabric, or a porous film. Specifically, the porous substrate may be polyolefins such as polyethylene and polypropylene, polyesters such as polyethylene terephthalate and polybutylene terephthalate, polyacetal, polyamide, polyimide, polycarbonate, polyetheretherketone, polyaryletherketone, polyetherimide, polyamideimide, polybenzimidazole, polyethersulfone, polyphenyleneoxide, cyclic olefin copolymer, polyphenylenesulfide, polyethylenenaphthalate, glass fiber, teflon, and/or polytetrafluoroethylene, and any two or more of them may be used. Among the porous substrates, a porous film is manufactured by a dry method or a wet method known in the art.

In an example embodiment, the porous substrate may have a porosity of 20 to 60%, 30 to 60%, 30 to 50%, or 35 to 45%, but the disclosed technology is not limited thereto.

In an example embodiment, the porous substrate may have a polar functional group introduced by performing a hydrophilic surface treatment, the polar functional group may be a carboxyl group, an aldehyde group, a hydroxyl group, and others, and the hydrophilic surface treatment may be, as an example, a corona discharge treatment or a plasma discharge treatment, but the disclosed technology is not limited thereto.

In an example embodiment, the thickness of the porous substrate is not particularly limited, and for example, may be 1 μm to 100 μm, 1 μm to 50 μm, 1 μm to 30 μm, 5 μm to 20 μm, or any value between the numerical values.

Another example embodiment of the disclosed technology provides a method for manufacturing a composite separator that includes: applying a composition for forming a ceramic layer including inorganic particles, a binder, and a particulate fusing agent on at least one surface of a porous substrate and drying the composition to form a ceramic layer, wherein the binder includes carboxymethyl cellulose and polyacrylamide, and the ceramic layer satisfies the following Equation 1:

$$0.9 < \frac{T \times ( W 1 + W 2 )}{W 2 \times D} < 2.4 \qquad [ Equation 1 ]$$

Wherein:
T is a thickness (μm) of the ceramic layer;
W1 is a content (wt %) of the binder relative to the total weight of the ceramic layer;
W2 is a content (wt %) of the particulate fusing agent relative to the total weight of the ceramic layer; and
D is an average particle diameter (μm) of the particulate fusing agent.

Since the porous substrate, the binder, and the inorganic particles have been described above, detailed description will be omitted.

The composition for forming a ceramic layer may be prepared by dispersing the binder and the inorganic particles, and the agglomerated inorganic particles may be dispersed using a ball mill.

The composition for forming a ceramic layer further includes a solvent, and the solvent may be water, lower alcohols such as ethanol, methanol, and propanol, solvents such as dimethylformamide, acetone, tetrahydrofuran, diethyl ether, methylene chloride, N-methyl-2-pyrrolidone, hexane, and cyclohexane, or a mixture thereof, but is not necessarily limited thereto.

In an example embodiment, though a solid content of the composition for forming a ceramic layer is not particularly limited, it may be, for example, 1 to 50 wt %, 5 to 30 wt %, or 10 to 30 wt %, but the disclosed technology is not limited thereto. In addition, the composition for forming a ceramic layer may have a viscosity based on a solid content of 25 wt % of 800 to 5,000 mPa-s, 800 to 4,000 mPa-s, 800 to 3,000 mPa-s, or 1,000 to 3,000 mPa-s. At such viscosity, the ceramic layer can be formed more easily, and the heat resistance and adhesive strength of the separator may be further improved.

In an example embodiment, although a method for applying or coating the composition for forming a ceramic layer on the porous substrate is not particularly limited, coating methods such as roll coating, spin coating, dip coating, bar coating, die coating, slit coating, or inkjet printing may be used.

In an example embodiment, the drying may be performed by drying by warm air, hot air, or low-humidity air, vacuum drying, or irradiation with far infrared rays, electron beams, or others. Since the drying temperature is not particularly limited, it may be appropriately adjusted depending on the experimental environment or the purpose, and for example, may be 30° C. to 120° C., 30° C. to 100° C., 50° C. to 80° C., or 50° C. to 70° C. The drying time is not particularly limited, but it may be 30 seconds to 300 seconds, 60 seconds to 300 seconds, 100 seconds to 300 seconds, 150 seconds to 250 seconds, or about 180 seconds.

Another example embodiment of the disclosed technology provides an electrochemical device including the composite separator according to an example embodiment, and the electrochemical device may be, as an example, a lithium secondary battery.

Specifically, the electrochemical device according to an example embodiment includes: a positive electrode, a negative electrode, and a composite separator, wherein the composite separator includes a porous substrate and a ceramic layer formed on at least one surface of the substrate, the ceramic layer includes inorganic particles, a binder that includes carboxymethyl cellulose and polyacrylamide, and a particulate fusing agent, wherein the ceramic layer satisfies the following Equation 1:

$$0.9 < \frac{T \times ( W 1 + W 2 )}{W 2 \times D} < 2.4 \qquad [ Equation 1 ]$$

wherein
T is a thickness (μm) of the ceramic layer;
W1 is a content (wt %) of the binder relative to the total weight of the ceramic layer;
W2 is a content (wt %) of the particulate fusing agent relative to the total weight of the ceramic layer; and
D is an average particle diameter (μm) of the particulate fusing agent.

Hereinafter, the electrochemical device based on an example embodiment will be described using a lithium secondary battery as an example, but it may be manufactured with a structure known in the art using a common manufacturing method and common materials in the art, except for including the composite separator implemented based on an example embodiment of the disclosed technology.

As an example, the lithium secondary battery may be manufactured using a common manufacturing method of placing a negative electrode, the composite separator, and a positive electrode sequentially, assembling them, and injecting an electrolyte to complete the battery.

### [Positive Electrode]

The positive electrode may include a positive electrode current collector and a positive electrode mixed layer on at least one surface of the positive electrode current collector, the positive electrode may be manufactured by forming the positive electrode mixed layer by applying a positive electrode material slurry on at least one surface of the positive electrode current collector, drying, and rolling, and the positive electrode material slurry may include a positive electrode active material and a binder, and if necessary, may further include a conductive material, a thickening agent, and others.

The positive electrode current collector may include a stainless steel, nickel, aluminum, titanium, or an alloy thereof, and may include aluminum or a stainless steel which is surface-treated with carbon, nickel, titanium, or silver. The thickness of the positive electrode current collector may be, for example, 10 μm to 50 μm, but the disclosed technology is not limited thereto.

The positive electrode active material is a compound capable of reversibly intercalating and deintercalating lithium ions and may be used without limitation as long as it is commonly used in the art, and as a non-limiting example, it may be a composite oxide of lithium with a metal selected from cobalt (Co), manganese (Mn), nickel (Ni), iron (Fe), niobium (Nb), magnesium (Mg), copper (Cu), zinc (Zn), molybdenum (Mo), tantalum (Ta), tungsten (W), aluminum (Al), or a combination thereof.

In an example embodiment, the positive electrode active material may be a lithium-nickel composite oxide, and the lithium-nickel composite oxide may further include one or more selected from cobalt, manganese, and aluminum. In some embodiments, the lithium-nickel composite oxide may include materials other than those listed above.

In an example embodiment, the positive electrode active material may include a lithium nickel-cobalt-manganese (NCM)-based composite oxide, and though the composition of the metal is not particularly limited, a high capacity (high-Ni) composition having a high nickel content may be used, and the content of Ni in the NCM-based lithium oxide (for example, a mole fraction of nickel of the total moles of nickel, cobalt, and manganese) may be 0.3 or more, 0.4 or more, 0.5 or more, 0.6 or more, 0.7 or more, or 0.8 or more. In some example embodiments, the content of Ni may be 0.8 to 0.95, 0.82 to 0.95, 0.83 to 0.95, 0.84 to 0.95, 0.85 to 0.95, or 0.88 to 0.95. The NCM-based composite oxide may include, for example, LiNi_{0.33}CO_{0.33}Mn_{0.33}O₂, LiNi_{0.4}CO_{0.2}Mn_{0.4}O₂, LiNi_{0.5}CO_{0.2}Mn_{0.3}O₂, LiNi_{0.6}CO_{0.2}Mn_{0.2}O₂, LiNi_{0.7}CO_{0.15}Mn_{0.15}O₂, LiNi_{0.8}CO_{0.1}Mn_{0.1}O₂, or others, but the disclosed technology is not limited thereto.

In an example embodiment, the positive electrode active material may be, for example, lithium cobalt oxide-based, lithium manganese oxide-based, lithium nickel oxide-based, lithium iron phosphate-based (LFP, e.g., LiFePO₄), lithium manganese phosphate-based (e.g., LiMnPO₄), lithium cobalt phosphate-based (e.g., LiCoPO₄), lithium iron pyrophosphate-based (e.g., Li₂FeP₂O₇) materials, and others.

The positive electrode binder is not particularly limited as long as it is commonly used in the art. In some embodiments, the positive electrode binder may include a nonaqueous binder and/or an aqueous binder or include a rubber-based binder and/or a fluorine-based binder, and for example, may include one or more selected from acryl-based polymers such as polyacrylate, polymethacrylate, polybutylacrylate, and polyacrylonitrile, fluorine-based polymers such as polyvinylidene fluoride, polyhexafluoropropylene, polyvinylidene fluoride-hexafluoropropylene, and polyvinylidene fluoride-trichloroethylene, polyvinyl acetate, polyethylene oxide, cellulose, modified cellulose, polyamide, polyacrylamide, rubber, elastomer, and others, but the disclosed technology is not limited thereto.

The conductive material may be added for increasing conductivity of the positive electrode mixed layer and/or mobility of lithium ions or electrons. For example, the conductive material may be a linear conductive material and/or a dot-shaped conductive material, and for example, may include carbon-based conductive materials such as graphite, carbon black, acetylene black, ketjen black, graphene, carbon nanotubes, vapor-grown carbon fiber (VGCF), carbon fiber, and carbon nanofiber, and/or metal-based conductive materials including tin, tin oxide, titanium oxide, perovskite materials such as LaSrCoO₃ and LaSrMnO₃, and others, but the disclosed technology is not limited thereto. As used herein, the term “dot-shaped conductive material” refers to a general spherical or particulate form of conductive material.

### [Negative Electrode]

The negative electrode may include a negative electrode current collector and a negative electrode mixed layer on at least one surface of the negative electrode current collector, the negative electrode may be manufactured by forming the negative electrode mixed layer by applying a negative electrode material slurry on at least one surface of the negative electrode current collector, drying, and rolling, and the negative electrode material slurry may include a negative electrode active material and a binder, and if necessary, may further include a conductive material, a thickening agent, and others.

The negative electrode current collector may include a copper foil, a nickel foil, a stainless steel foil, a titanium foil, a nickel foam, a copper foam, a polymer substrate coated with a conductive metal, and others. The thickness of the negative electrode current collector may be, for example, 10 μm to 50 μm, but the disclosed technology is not limited thereto.

The negative electrode active material is a material capable of adsorbing and desorbing lithium ions and may be used without limitation as long as it is commonly used in the art, and as a non-limiting example thereof, carbon-based materials such as crystalline carbon, amorphous carbon, a carbon composite, and carbon fiber; lithium metal; lithium alloy; silicon (Si)-containing materials, tin (Sn)-containing materials, and others may be used.

An example of the amorphous carbon may include hard carbon, soft carbon, coke, mesocarbon microbeads (MCMB), mesophase pitch-based carbon fibers (MPCF), and others, and an example of the crystalline carbon may include graphite-based carbon such as natural graphite, artificial graphite, graphitized coke, graphitized MCMB, and graphitized MPCF.

An element included in the lithium alloy may include aluminum, zinc, bismuth, cadmium, antimony, silicon, lead, tin, gallium, indium, or others.

The silicon-containing material may provide more increased capacity characteristics. The silicon-containing material may include Si, SiOₓ (0<x≤2), metal-doped SiOₓ (0<x≤2), a silicon-carbon composite, and others, the metal may include lithium and/or magnesium, and the metal-doped SiOₓ (0<x≤2) may include a metal silicate. The materials described above which may be used in manufacture of the positive electrode may be used as the binder, the conductive material, and the thickening agent of the negative electrode.

The negative electrode binder is not particularly limited as long as it is commonly used in the art, and may be rubber-based binders such as a styrene-butadiene rubber (SBR)-based binder, carboxymethyl cellulose (CMC), polyacrylic acid, poly(3,4 ethylenedioxythiophene) (PEDOT)-based binders, and others.

### [Electrolyte]

In an example embodiment, the electrolyte may be a nonaqueous electrolytic solution, and the nonaqueous electrolytic solution may include a lithium salt as an electrolyte and an organic solvent.

The lithium salt is represented by, for example, Li⁺X⁻, and an anion of the lithium salt (X⁻) may be exemplified by F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, (CF₃CF₂SO₂)₂N⁻, and others. In some embodiments, the lithium salt may include materials other than those listed above.

The organic solvent sufficiently dissolves the lithium salt and the additive, and may include an organic compound having no reactivity in a battery. The organic solvent may include, for example, at least one of carbonate-based solvents, ester-based solvents, ether-based solvents, ketone-based solvents, alcohol-based solvents, or aprotic solvents. The organic solvent may include, for example, one or more selected from propylene carbonate, ethylene carbonate, butylene carbonate, diethyl carbonate, dimethyl carbonate, ethyl methyl carbonate, methylpropyl carbonate, ethylpropyl carbonate, dipropyl carbonate, vinylene carbonate, methyl acetate, ethyl acetate, n-propyl acetate, 1,1-dimethylethyl acetate, methyl propionate, ethyl propionate, fluoroethyl acetate, difluoroethyl acetate, trifluoroethyl acetate, dibutylether, tetraethylene glycol dimethylether, diethylene glycol dimethylether, tetrahydrofuran, 2-methyltetrahydrofuran, ethyl alcohol, isopropyl alcohol, dimethylsulfuroxide, acetonitrile, dimethoxyethane, diethoxyethane, sulfolane, γ-butyrolactone, propylene sulfite, and others. In some embodiments, the organic solvent may include materials other than those listed above.

Hereinafter, the example embodiments described above will be described in detail through the following examples. However, the following examples are only for description, and do not limit the scope of a right.

### [Method for Measuring Physical Properties]

### 1) Glass Transition Temperature (T_{g})

A heat capacity of a sample according to heating at a rate of 10° C./min in a range of −100° C. to 250° C., using a differential scanning calorimetry (DSC) was measured, and a temperature of a middle point of an interval where the heat capacity of the sample rapidly changed was set as a glass transition temperature.

### 2) Thickness

A composite separator was laminated in 10 layers, the thickness was measured at ambient temperature and atmospheric pressure by Mitutoyo (ID-C112X) to derive an average thickness of the 10 layers of the composite separator, and the average thickness was divided by 10 again to determine the thickness of the composite separator. A value obtained by subtracting the thickness of a porous substrate from the thickness of the composite separator was set as a total thickness of the ceramic layer.

The thickness of the porous substrate was obtained by laminating only the porous substrate in 10 layers, measuring the thickness by Mitutoyo (ID-C112X) to derive the average thickness of the 10 layers, and dividing the average thickness by 10. In the case of after forming the ceramic layer, the ceramic layer was detached, sufficient drying was performed, and the average thickness of the porous substrate from which the ceramic layer was detached was derived by the method described above.

### 3) Adhesive Strength

### [Cardboard Test]

A composite separator was cut into a size of 5 cm×10 cm to prepare a specimen, and a black cardboard and a rubber pad having a size of 2 cm×10 cm were placed sequentially on the ceramic layer of the composite separator specimen. The cardboard was pulled out horizontally at a speed of 0.1 m/s in for a distance of 60 mm a state of applying a force of 10 N to the rubber pad using a pressing device, adhesive strength was evaluated depending on a degree of foreign matter smeared on the surface of the cardboard, and the foreign matter may be constituent components of the ceramic layer, for example, inorganic particles, a binder, or a combination thereof.

### [Evaluation of Degree of Smeared Foreign Matter]

After the cardboard test, the surface of the cardboard was photographed with an optical camera and imaged, and an area of the smeared foreign matter was measured. Specifically, an indirect lighting was installed with an LED lamp in the visible light range having a 60° slope, and the cardboard was photographed with a 640 M pixel optical camera at a height of 40 cm from the sample (cardboard). The photographed cardboard image was loaded with an Image J program, only an area through which the separator and the rubber pad were passed was selected and cut using a crop function, an image file format of the cut area was converted into a 8 bit image, and a Sharpen filter was applied to the image to adjust the brightness and the contrast of the image so that it is easy to distinguish between the cardboard and white foreign matter. A threshold was applied to the image to convert it into a binary image, an Analyze Particles function was executed to calculate a ratio of an area occupied by white foreign matter to the total area, and adhesive strength was evaluated based on the following criteria:

$$\begin{matrix}A : < 1.5 \% \\ B : 1.5 \% - 5 \% \\ C : > 5 \%\end{matrix}$$

### Example 1

2 parts by weight of 1,2-benzisothiazolin-3-one (DIO2) as a dispersing agent was mixed with 100 parts by weight of boehmite having an average particle diameter (D50) of 0.3 μm as inorganic particles in water to prepare a slurry having a solid content of 45 wt %.

A binder of carboxymethyl cellulose (CMC) having a degree of substitution of 0.9 and a weight-average molecular weight of 200,000 g/mol and polyacrylamide (PAAm) (Mw 200,000 g/mol, Sigma Aldrich) at a weight ratio of 20:80 was mixed with the slurry prepared above, a polystyrene-polybutyl methacrylate-polymethyl methacrylate block copolymer (PS-PBMA-PMMA) (D50:2.5 μm, Tg: 62° C.) was added as a particulate fusing agent to prepare a composition for forming a ceramic layer, and the weight ratio of inorganic particles/binder/particulate fusing agent was 96/2.3/1.7.

Both surfaces of a polyethylene film substrate having a thickness of 9 μm (porosity: 35%-45%, SKIET) were subjected to a corona discharge treatment (power density: 2 W/m²) to introduce a surface polar group, and the corona surface treatment at this time was performed at a speed of 5 mpm (meter per minute). The composition for forming a ceramic layer was applied on both surfaces of the corona surface-treated polyethylene film substrate identically, bar-coated, and dried at 50° C. to manufacture a composite separator having ceramic layers at the same thickness formed on both surfaces.

### Example 2

The process was performed in the same manner as in Example 1, except that the weight ratio of inorganic particles/binder/particulate fusing agent was 95/3.3/1.7.

### Example 3

The process was performed in the same manner as in Example 1, except that the weight ratio of inorganic particles/binder/particulate fusing agent was 95/3.8/1.2, and the thickness of the ceramic layer was changed as shown in Table 1.

### Example 4

The process was performed in the same manner as in Example 1, except that the weight ratio of inorganic particles/binder/particulate fusing agent was 96/2/2, and the thickness of the ceramic layer was changed as shown in Table 1.

### Example 5

The process was performed in the same manner as in Example 1, except that the weight ratio of inorganic particles/binder/particulate fusing agent was 95/3/2, and the thickness of the ceramic layer was changed as shown in Table 1.

### Example 6

The process was performed in the same manner as in Example 1, except that the weight ratio of inorganic particles/binder/particulate fusing agent was 95/3.4/1.6, and the thickness of the ceramic layer was changed as shown in Table 1.

### Example 7

The process was performed in the same manner as in Example 1, except that PS-PBMA-PMMA (D50:5.0 μm, Tg: 62° C.) was used as the particulate fusing agent, the weight ratio of inorganic particles/binder/particulate fusing agent was 95/3.3/1.7, and the thickness of the ceramic layer was changed as shown in Table 1.

### Example 8

The process was performed in the same manner as in Example 7, except that the weight ratio of inorganic particles/binder/particulate fusing agent was 96/2.8/1.2.

### Example 9

The process was performed in the same manner as in Example 7, except that the weight ratio of inorganic particles/binder/particulate fusing agent was 95/3.8/1.2, and the thickness of the ceramic layer was changed as shown in Table 1.

### Comparative Example 1

The process was performed in the same manner as in Example 1, except that the weight ratio of inorganic particles/binder/particulate fusing agent was 97/1.3/1.7.

### Comparative Example 2

The process was performed in the same manner as in Example 1, except that the weight ratio of inorganic particles/binder/particulate fusing agent was 94/4.8/1.2, and the thickness of the ceramic layer was changed as shown in Table 1.

### Comparative Example 3

The process was performed in the same manner as in Example 1, except that the weight ratio of inorganic particles/binder/particulate fusing agent was 97/1/2, and the thickness of the ceramic layer was changed as shown in Table 1.

### Comparative Example 4

The process was performed in the same manner as in Example 1, except that the weight ratio of inorganic particles/binder/particulate fusing agent was 94/4.65/1.35, and the thickness of the ceramic layer was changed as shown in Table 1.

### Comparative Example 5

The process was performed in the same manner as in Example 1, except that PAAm was used alone as the binder.

### Comparative Example 6

The process was performed in the same manner as in Example 7, except that PAAm was used alone as the binder.

### Comparative Example 7

The process was performed in the same manner as in Example 1, except that PS-PBMA-PMMA (D50:0.9 μm, Tg: 62° C.) was used as the particulate fusing agent.

The physical properties of the composite separators obtained in the examples and the comparative examples were measured by the methods described in the [Method for measuring physical properties] above, and the values obtained by calculating the value of the following Equation 1 and truncating the third decimal place are shown in the following Table 1.

The composite separators obtained in the examples and the comparative examples all had ceramic layers having the same thickness on both surfaces of the substrate, and the value of half of the total thickness of the ceramic layer measured by the method for measuring physical properties was set as the thickness (T) of the ceramic layer formed on one surface.

$$\frac{T \times ( W 1 + W 2 )}{W 2 \times D} \qquad [ Equation 1 ]$$

wherein T is the thickness (μm) of the ceramic layer; W1 is the content (wt %) of the binder to the total weight of the ceramic layer; W2 is the content (wt %) of the particulate fusing agent to the total weight of the ceramic layer; and D is the average particle diameter (μm) of the particulate fusing agent.

TABLE 1

| | Total | | | | | | |
|---|---|---|---|---|---|---|---|
| | thickness | | | | | Heat | |
| | (μm) of | | | | | shrinkage | |
| | ceramic | T | D | Equation | Adhesive | rate (%) | |
| | layer | (μm) | (μm) | 1 | strength | MD | TD |
| Example 1 | 2 | 1 | 2.5 | 0.94 | B | 2 | 1 |
| Example 2 | 2 | 1 | 2.5 | 1.17 | B | 1.9 | 1.2 |
| Example 3 | 2.4 | 1.2 | 2.5 | 2.0 | B | 2 | 0.9 |
| Example 4 | 3 | 1.5 | 2.5 | 1.2 | A | 0.1 | 0.1 |
| Example 5 | 3 | 1.5 | 2.5 | 1.5 | A | 0.2 | 0.1 |
| Example 6 | 3.4 | 1.7 | 2.5 | 2.12 | A | 0.2 | 0.1 |
| Example 7 | 4 | 2 | 5.0 | 1.17 | A | 0.1 | 0.1 |
| Example 8 | 4 | 2 | 5.0 | 1.33 | A | 0.1 | 0.1 |
| Example 9 | 4.4 | 2.2 | 5.0 | 1.83 | A | 0.1 | 0.1 |
| Comparative | 2 | 1 | 2.5 | 0.70 | C | 20 | 19 |
| Example 1 | | | | | | | |
| Comparative | 2.4 | 1.2 | 2.5 | 2.4 | A | 14 | 18 |
| Example 2 | | | | | | | |
| Comparative | 3 | 1.5 | 2.5 | 0.9 | C | 15 | 14 |
| Example 3 | | | | | | | |
| Comparative | 3 | 1.5 | 2.5 | 2.66 | A | 10 | 9 |
| Example 4 | | | | | | | |
| Comparative | 2 | 1 | 2.5 | 0.94 | C | 13 | 12 |
| Example 5 | | | | | | | |
| Comparative | 4 | 2 | 5.0 | 1.17 | C | 15 | 13 |
| Example 6 | | | | | | | |
| Comparative | 2 | 1 | 0.9 | 2.61 | A | 1.8 | 1.2 |
| Example 7 | | | | | | | |

### Evaluation Example

### Evaluation 1. Electrode Fusion Strength

A positive electrode and a negative electrode were manufactured as follows, and fusion strength between the electrode and the composite separators obtained in the above examples was evaluated.

94 wt % of LiCoO₂ as a positive active material, 2.5 wt % of polyvinylidene fluoride as an adhesive, and 3.5 wt % of carbon black as a conductive agent were added to N-methyl-2-pyrrolidone (NMP) as a solvent, and stirring was performed to prepare a uniform positive electrode slurry. An aluminum foil having a thickness of 30 μm was coated with the slurry, dried at a temperature of 120° C., and pressed to manufacture a positive electrode plate having a thickness of 150 μm.

95 wt % of artificial graphite as the negative active material, 3 wt % of acrylic latex having Tg of −52° C. (product name: BM900B, solid content: 20 wt %), and 2 wt % of carboxymethyl cellulose (CMC) as a thickener were added to water as the solvent, and stirred, thereby preparing uniform negative electrode slurry. A copper foil having a thickness of 20 μm was coated with the slurry, dried at a temperature of 120° C., and pressed to manufacture a negative electrode plate having a thickness of 150 μm.

A composite separator was laminated between 4 sheets of the positive electrode (negative electrode) manufactured above, and pressing was performed at 90° C. and 1 MPa for 30 seconds using a heat press machine to prepare each fusion strength evaluation sample for the positive electrode and the negative electrode. When the sample was lifted vertically, the number of attached electrodes was counted, the fusion strength between the composite separator and each of the positive electrode and the negative electrode was evaluated, and the results are shown in the following Table 2.
1/4: 1 out of 4 sheets of electrode was fused.
2/4: 2 out of 4 sheets of electrode were fused.
3/4: 3 out of 4 sheets of electrode were fused.
4/4: 4 out of 4 sheets of electrode were all fused.

TABLE 2

Electrode fusion strength

| | Positive electrode | Negative electrode |
|---|---|---|
| Example 1 | 4/4 | 4/4 |
| Example 2 | 4/4 | 4/4 |
| Example 3 | 4/4 | 4/4 |
| Example 4 | 4/4 | 4/4 |
| Example 5 | 4/4 | 4/4 |
| Example 6 | 4/4 | 4/4 |
| Example 7 | 4/4 | 4/4 |
| Example 8 | 4/4 | 4/4 |
| Example 9 | 4/4 | 4/4 |
| Comparative | 0/0 | 0/0 |
| Example 7 | | |

Referring to Tables 1 and 2, it was found that the composite separator implemented based on an example embodiment of the disclosed technology exhibited excellent adhesive strength both between the inorganic particles in the ceramic layer and at the interfaces between the substrate and the ceramic layer, thereby effectively suppressing heat shrinkage. In addition, the composite separator implemented based on an example embodiment was confirmed to have fusion strength with both the positive electrode and the negative electrode, and the electrochemical device employing the composite separator according to an example embodiment may secure heat resistance and safety, while also being favorable for achieving higher capacity and higher output.

However, the composite separators of Comparative Examples 1 to 4, which included the same components as example embodiments of the disclosed technology but did not satisfy the range of Equation 1 (0.9<T×(W1+W2)/(W2×D)<2.4), exhibited reduced adhesion and/or heat resistance and showed greatly increased heat shrinkage rates. In addition, it was found that Comparative Example 7 exhibited significantly reduced fusion strength with the electrode and hardly exhibited any fusion strength.

In addition, it was confirmed that Comparative Examples 5 and 6, which employed PAAm alone as the binder, exhibited greatly reduced adhesive strength and heat resistance as compared with the composite separator implemented based on an example embodiment. Furthermore, the air permeability was deteriorated, resulting in an increased air permeability value (sec/100 cc).

As demonstrated in Tables 1 and 2, the composite separators prepared within the range defined by Equation 1 (0.9<T×(W1+W2)/(W2×D)<2.4) exhibit excellent fusion strength with electrodes, low heat shrinkage, and strong adhesion between inorganic particles and between the ceramic layer and the substrate. In contrast, outside this range, composite separators may show severe deterioration in at least one of these properties, such as significantly increased heat shrinkage or poor adhesive strength.

The composite separator of the disclosed technology may be widely applied to a green technology field such as electric vehicles, battery charging stations, and other solar power generations and wind power generations using batteries. In addition, the separator of the disclosed technology may be used in eco-friendly electric vehicles, hybrid vehicles, and others for preventing climate change by suppressing air pollution and greenhouse gas emissions.

The composite separator based on an example embodiment including a porous substrate; and a ceramic layer including inorganic particles, a binder, and a particulate fusing agent on the substrate may provide sufficient fusion strength with an electrode without requiring a separate adhesive layer on the ceramic layer, and can decrease internal resistance and improve electrical performance.

In addition, although the composite separator based on an example embodiment is formed with a very small thickness, it may exhibit excellent heat resistance as compared with a conventional separator having a ceramic layer of the same thickness. Furthermore, it can exhibit excellent adhesive strength between inorganic particles and between inorganic particles and the substrate, thereby effectively suppressing desorption of inorganic particles and shrinkage at high temperatures.

In addition, the composite separator based on an example embodiment has excellent productivity and is favorable for application to actual commercialization. Furthermore, an electrochemical device employing the composite separator based on an example embodiment may simultaneously satisfy safety, high capacity, and high output characteristics.

Only specific examples of implementations of certain embodiments are described. Variations, improvements and enhancements of the disclosed embodiments and other embodiments may be made based on the disclosure of this patent document.

What is claimed is:

1. A composite separator comprising:
a porous substrate; and
a ceramic layer disposed on at least one surface of the substrate,
wherein the ceramic layer comprises: inorganic particles; a binder including carboxymethyl cellulose and polyacrylamide; and a particulate fusing agent,
wherein the ceramic layer satisfies the following Equation 1:
$$0.9 < \frac{T \times ( W 1 + W 2 )}{W 2 \times D} < 2.4 \qquad [ Equation 1 ]$$
Wherein:
T is a thickness in microns (μm) of the ceramic layer;
W1 is a content weight percentage (wt %) of the binder relative to a total weight of the ceramic layer;
W2 is a content (wt %) of the particulate fusing agent relative to the total weight of the ceramic layer; and
D is an average particle diameter in microns (μm) of the particulate fusing agent.

2. The composite separator of claim 1, wherein an average particle diameter (D50) of the particulate fusing agent is in a range of 1 μm to 10 μm.

3. The composite separator of claim 1, wherein the ceramic layer has a total thickness in a range of 1 μm to 20 μm.

4. The composite separator of claim 1, wherein the binder includes the carboxymethyl cellulose and the polyacrylamide at a weight ratio in a range of 10 to 40: 90 to 60.

5. The composite separator of claim 1, wherein the carboxymethyl cellulose has a weight-average molecular weight of at least 180,000 g/mol and a degree of substitution in a range of 0.6 to 1.2.

6. The composite separator of claim 1, wherein the inorganic particles have an average particle diameter (D50) in a range of 0.01 μm to 1 μm.

7. The composite separator of claim 1, wherein the inorganic particles include at least one of boehmite, BaSO₄, CeO₂, MgO, CaO, ZnO, Al₂O₃, TiO₂, BaTiO₃, HfO₂, SrTiO₃, SnO₂, NiO, ZrO₂, Y₂O₃, or SiC.

8. The composite separator of claim 1, wherein the inorganic particles are included at 90 to 99 wt % with respect to the total weight of the ceramic layer.

9. The composite separator of claim 1, wherein the binder is included at 0.1 wt % to 10 wt % with respect to the total weight of the ceramic layer.

10. The composite separator of claim 1, wherein the particulate fusing agent is included at 0.1 wt % to 10 wt % with respect to the total weight of the ceramic layer.

11. The composite separator of claim 1, wherein the binder and the particulate fusing agent are included at a weight ratio in a range of 5:5 to 8:2.

12. The composite separator of claim 1, wherein the particulate fusing agent has a glass transition temperature (T_{g}) in a range of 40° C. to 80° C.

13. The composite separator of claim 1, wherein the porous substrate is hydrophilically surface-treated.

14. The composite separator of claim 1, wherein the composite separator exhibits heat shrinkage rates in machine direction (MD) and transverse direction (TD) of 4% or less, wherein the heat shrinkage rates in MD and TD are measured after the composite separator is allowed to stand at 150° C. for 60 minutes.

15. The composite separator of claim 1, wherein, when the composite separator is subjected to a cardboard test, a ratio of an area occupied by foreign matter smeared on a surface of a cardboard to a total area of the cardboard is 5% or less,
wherein the cardboard test comprises:
placing a black cardboard and a rubber pad having a size of 2 cm×10 cm sequentially on a ceramic layer of a composite separator specimen having a size of 5 cm×10 cm;
pulling the cardboard horizontally at a speed of 0.1 m/s while applying a fore of 10 N to the rubber pad using a pressing device; and
evaluating a degree of foreign matter smeared on the surface of the cardboard.

16. An electrochemical device comprising a positive electrode, a negative electrode, and a composite separator,
wherein the composite separator comprises:
a porous substrate; and
a ceramic layer disposed on at least one surface of the substrate,
wherein the ceramic layer comprises: inorganic particles; a binder including carboxymethyl cellulose and polyacrylamide; and a particulate fusing agent,
wherein the ceramic layer satisfies the following Equation 1:
$$0.9 < \frac{T \times ( W 1 + W 2 )}{W 2 \times D} < 2.4 \qquad [ Equation 1 ]$$
wherein
T is a thickness in microns (μm) of the ceramic layer;
W1 is a content weight percentage (wt %) of the binder relative to a total weight of the ceramic layer;
W2 is a content weight percentage (wt %) of the particulate fusing agent relative to the total weight of the ceramic layer; and
D is an average particle diameter in microns (μm) of the particulate fusing agent.

17. The electrochemical device of claim 16, wherein an average particle diameter (D50) of the particulate fusing agent is in a range of 1 μm to 10 μm.

18. The electrochemical device of claim 16, wherein the binder includes the carboxymethyl cellulose and the polyacrylamide at a weight ratio in a range of 10 to 40: 90 to 60.

19. The electrochemical device of claim 16, wherein the particulate fusing agent is included at 0.1 wt % to 10 wt % with respect to the total weight of the ceramic layer.

20. The electrochemical device of claim 16, wherein the binder and the particulate fusing agent are included at a weight ratio in a range of 5:5 to 8:2.
